(19) United States
(12) Patent Application Publication
(10) Pub. No.: US 2015/0280867 A1
(43) Pub. Date: Oct. 1, 2015

(54) Method and System Applied in Physical Uplink Shared Channel (PUSCH) Hybrid Automatic Repeat Request (HARQ) Timing for Carrier Aggregation (CA)

(71) Applicant: CHINA MOBILE COMMUNICATIONS CORPORATION, Beijing (CN)

(72) Inventors: Lu Han, Beijing (CN); Lijie Hu, Beijing (CN); Xiaodong Shen, Beijing (CN)

(21) Appl. No.: 14/428,393

(22) PCT Filed: Sep. 25, 2013
(86) PCT No.: PCT/CN2013/084187

§ 371 Date: Mar. 16, 2015

(30) Foreign Application Priority Data
Sep. 26, 2012 (CN) 201210365107.7

(51) Int. Cl. H04L 1/18; H04L 12/841; H04W 72/04; H04L 5/00; H04L 12/807

(52) U.S. Cl. CPC H04L 1/1887; H04L 1/1812; H04L 5/0053; H04L 47/27; H04W 72/0446; H04L 47/283

(57) ABSTRACT

The present disclosure discloses a method and a system applied in a Physical Uplink Shared Channel (PUSCH) Hybrid Automatic Repeat Request (HARQ) timing for Carrier Aggregation (CA). when a Round-Trip Time (RTT) of a scheduling cell is not equal to 10 ms, an HARQ of the PUSCH on a scheduled cell may follow a timing mode of a time slot configuration of config#1 defined by the 3rd Generation Partnership Project (3GPP). By using the solution according to the present disclosure, it is ensured that there is at least one sub-frame being able to work properly in the PUSCH on the scheduled cell and the transmission efficiency is maximized except for two circumstances where the time slot configuration of the scheduling cell and the time slot configuration of the scheduled cell are (config#6, config#0) and (config#0, config#6) defined by the 3GPP.

### CROSS-REFERENCE TO RELATED APPLICATION

This application claims a priority to Chinese Patent Application No. 201210365107.7 filed with State Intellectual Property Office (SIPO) of the P.R.C on Sep. 26, 2012, the title of which is “method and system applied in Physical Uplink Shared Channel (PUSCH) Hybrid Automatic Repeat Request (HARQ) timing for Carrier Aggregation (CA)” and the disclosures of which are incorporated in their entirety by reference herein.

### TECHNICAL FIELD

The present disclosure relates to the field of wireless communication technology, and more particularly to a method and a system applied in a Physical Uplink Shared Channel (PUSCH) Hybrid Automatic Repeat Request (HARQ) timing for Carrier Aggregation (CA).

### BACKGROUND

For a Carrier Aggregation (CA), a Pcell or Scheduling cell and a Scell or scheduled cell work in different time slot configuration in Time Division Duplexing (TDD). Therefore, there needs to design a solution of the Hybrid Automatic Repeat Request (HARQ) timing for the scheduled cells, so as to ensure that the sub-carriers perform the HARQ normally.

Table 1 shows different TDD time slot configurations having seven formats, where D represents a downlink sub-frame, U represents an uplink sub-frame, and S represents a special sub-frame.

TABLE 1

| | Downlink- | | | | | | | | | | |
|---|---|---|---|---|---|---|---|---|---|---|---|
| | to-Uplink | | | | | | | | | | |
| Uplink- | Switch- | | | | | | | | | | |
| downlink | point | Subframe number | | | | | | | | | |
| configuration | periodicity | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 5 ms | D | S | U | U | U | D | S | U | U | D |

For scheduling cells and scheduled cells having different time slot configurations, a timing mode of a Physical Uplink Shared Channel (PUSCH) HARQ of the scheduled cell needs to be designed. For example, according to Table 2, the scheduling cell follows the configuration 1 (config#1), the scheduled cell follows the configuration 2 (config#2) and the PUSCH HARQ timing of the scheduled cell follows the timing mode of the scheduling cell, i.e., config#1.

TABLE 2

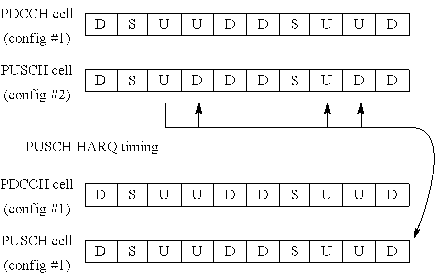

In the current 3^{rd} Generation Partnership Project (3GPP) definition, a classification is made according to the time slot configurations of the scheduling cell and the scheduled cell, as follows:

TABLE 3

| HARQ/scheduling | | | | | | | | |
|---|---|---|---|---|---|---|---|---|
| timing of PUSCH | | | | | | | | |
| on Scheduled | | | | | | | | |
| Cell follows | | | | | | | | |
| TDD UL-DL | | Scheduling cell SIB-1 UL-DL Configuration | | | | | | |
| Configuration # | | 0 | 1 | 2 | 3 | 4 | 5 | 6 |
| Scheduled cell | 0 | | B | B | B | B | B | D |
| SIB-1 UL-DL | 1 | D | | B | C | B | B | D |
| Configuration | 2 | D | A | | C | C | B | D |
| | 3 | D | C | C | | B | B | D |
| | 4 | D | A | C | A | | B | D |
| | 5 | D | A | A | A | A | | D |
| | 6 | D | B | B | B | B | B | |

| | | | | |
|---|---|---|---|---|
| Notes: | Case A | Case B | Case C | Case D |

where, Case A:

an uplink (UL) time slot of a scheduled cell is a subset of an uplink time slot of a scheduling cell, and a Round-Trip Time (RTT) of the scheduling cell is 10 ms;

### Case B:

a UL time slot of the scheduled cell is a superset of a UL time slot of the scheduling cell, and the RTT of the scheduling cell is 10 ms;

### Case C:

a UL time slot of the scheduled cell is neither a subset nor a superset of a UL time slot of the scheduling cell, and the RTT of the scheduling cell is 10 ms;

### Case D:

the RTT of the scheduling cell is not equal to 10 ms.

In the existing solution, with respect to Case D, it is recommended to use the PUSCH HARQ timing on the scheduled cell. However, the main problem with respect to this solution is that, since the RTT of the scheduling cell is not 10 ms, both the UL_grant scheduling information and A/N feedback information need to be sent in the DL time slot on the scheduling cell. And therefore, if the PUSCH HARQ timing on the scheduled cell is used, it will occur that there is no UL time slot being able to work properly on the scheduled cell.

TABLE 4

| | #0 | #1 | #2 | #3 | #4 | #5 | #6 | #7 | #8 | #9 |
|---|---|---|---|---|---|---|---|---|---|---|
| Config 0 | | | 6/5 | 0/6 | 0/0 | | | 1/0 | 5/1 | 5/5 |
| Config 1 | | | 6 | 9 | | | | 1 | 4 | |
| Config 2 | | | 8 | | | | | 3 | | |
| Config 3 | | | 8 | 9 | 0 | | | | | |
| Config 4 | | | 8 | 9 | | | | | | |
| Config 5 | | | 8 | | | | | | | |
| Config 6 | | | 6/5 | 9/6 | 0/9 | | | 1/0 | 5/1 | |

Table 4 shows the UL_grant scheduling time slot and A/N feedback time slot (both of which are DL time slots) corresponding to the UL time slot in different TDD time slot configurations. In the table, the blank cells represent DL time slots while the cells with numbers A/B therein represent UL time slots, where A represents performing A/N feedback in the A-th DL time slot and B represents performing UL-grant scheduling of the B-th DL time slot, in the B-th DL time slot of the pre-sub-frame.

With sub-frame#2 in config 0 as an example, 6/5 represents UL sub-frame #2, feedbacking its A/N information in sub-frame #6 and transmitting the UL_grant scheduling information in sub-frame #5.

TABLE 5

| 0 | 1 | 2 | 3 | 4 | 5 | 6 | 7 | 8 | 9 | 0 | 1 | 2 | 3 | 4 | 5 | 6 | 7 | 8 | 9 | 0 | 1 | 2 | 3 | 4 |
|---|---|---|---|---|---|---|---|---|---|---|---|---|---|---|---|---|---|---|---|---|---|---|---|---|
| D | S | U | U | U | D | S | U | U | U | D | S | U | U | U | D | S | U | U | U | D | S | U | U | U |
| | | U | | | | a | | | | | | | U | | | | | | | a | | | | U |
| | | | U | | | | | | | a | | | | U | | | | | | a | | | | |
| | | | | U | | | | | | a | | | | | | | U | | | | a | | | |
| | | | | | | | U | | | | a | | | | | | | U | | | | | | |
| | | | | | | | | U | | | | | | | a | | | | U | | | | | |
| | | | | | | | | | U | | | | | | a | | | | | | | U | | |
| | | | | | | | | | | | | U | | | | a | | | | | | | U | |
| 5 | 6 | 7 | 8 | 9 | 0 | 1 | 2 | 3 | 4 | 5 | 6 | 7 | 8 | 9 | 0 | 1 | 2 | 3 | 4 | 5 | 6 | 7 | 8 | 9 |
| D | S | U | U | U | D | S | U | U | U | D | S | U | U | U | D | S | U | U | U | D | S | U | U | U |
| | | | | | a | | | | | | | U | | | | | | | | | | | | |
| | | U | | | | a | | | | | | | U | | | | | | | | | | | |
| | | | U | | | | | | | a | | | | U | | | | | | | | | | |
| a | | | | U | | | | | | a | | | | | | | U | | | | | | | |
| a | | | | | | | U | | | | a | | | | | | | U | | | | | | |
| | a | | | | | | | U | | | | | | | a | | | | U | | | | | |
| | | | | | a | | | | U | | | | | | a | | | | | | | U | | |

Based on table 4 and table 5, a case where each UL sub-frame is scheduled when the timing mode of the scheduled cell is used will be analyzed.

Table 6 shows the transmission of UL time slot in the scheduled cell when PUSCH follows the scheduled cell HARQ timing, “✓” represents that scheduling and feedbacking A/N normally can be made, while “x” represents that for such time slot, a corresponding DL time slot to be scheduled or feedbacked with A/N cannot be found on the scheduling cell.

TABLE 6

| | #0 | #1 | #2 | #3 | #4 | #5 | #6 | #7 | #8 | #9 |
|---|---|---|---|---|---|---|---|---|---|---|
| {6, 0} | | | ✓ | ✓ | ✓ | | | ✓ | ✓ | ✓ |
| {6, 1} | | | ✓ | ✓ | | | | ✓ | x | |
| {6, 2} | | | x | | | | | x | | |
| {6, 3} | | | x | ✓ | ✓ | | | | | |
| {6, 4} | | | x | ✓ | | | | | | |
| {6, 5} | | | x | | | | | | | |
| {0, 1} | | | ✓ | x | | | | ✓ | x | |
| {0, 2} | | | x | | | | | x | | |
| {0, 3} | | | x | x | ✓ | | | | | |
| {0, 4} | | | x | x | | | | | | |
| {0, 5} | | | x | | | | | | | |
| {0, 6} | | | ✓ | x | x | | | ✓ | ✓ | |

From Table 6, it can be seen that, if the scheduled cell is used, it cannot be ensured that there is at least one UL time slot being able to work properly in a combination of five (5) kinds of CAs, that is, (scheduling cell, scheduled cell)=(config#6, config#2), (config#6, config#5), (config#0, config#2), (config#0, config#4) or (config#0, config#5). In these situations, if the transmission of PUSCH HARQ timing on the scheduled cell is used, then there is no UL time slot to be transmitted.

### SUMMARY

In order to solve the problem that when a Round-Trip Time (RTT) of a scheduling cell is not equal to 10 ms, a Physical Uplink Shared Channel (PUSCH) Hybrid Automatic Repeat Request (HARQ) on a scheduled cell cannot be achieved in the related art, the present disclosure provides a method and a system applied in a PUSCH HARQ timing for Carrier Aggregation (CA) which can ensure that when a Round-Trip Time (RTT) of a scheduling cell is not equal to 10 ms, there is at least one sub-frame being able to work properly in the PUSCH on the scheduled cell.

In an aspect, the present disclosure provides a method, which is applied in a Physical Uplink Shared Channel (PUSCH) Hybrid Automatic Repeat Request (HARQ) timing for Carrier Aggregation (CA), wherein when a Round-Trip Time (RTT) of a scheduling cell is not equal to 10 ms, an HARQ of the PUSCH on a scheduled cell follows a timing mode of a time slot configuration of config#1 defined by the 3rd Generation Partnership Project (3GPP).

In another aspect, the present disclosure provides a method, which is applied in a Physical Uplink Shared Channel (PUSCH) Hybrid Automatic Repeat Request (HARQ) timing for Carrier Aggregation (CA), wherein when a Round-Trip Time (RTT) of a scheduling cell is not equal to 10 ms, a timing mode of an HARQ of a PUSCH on a scheduled cell follows a mode where the 0th, 4th, 5th and 9th sub-frames are downlink sub-frames, the 1st and 6th sub-frames are special sub-frames, and the 2nd, 3rd, 7th and 8th sub-frames are uplink sub-frames.

In yet another aspect, the present disclosure provides a Carrier Aggregation (CA) system, wherein when a Round-Trip Time (RTT) of a scheduling cell is not equal to 10 ms, a Hybrid Automatic Repeat Request (HARQ) of a Physical Uplink Shared Channel (PUSCH) on a scheduled cell follows a timing mode of a time slot configuration of config#1 defined by the 3rd Generation Partnership Project (3GPP).

In still yet another aspect, the present disclosure provides a Carrier Aggregation (CA) system, wherein when a Round-Trip Time (RTT) of a scheduling cell is not equal to 10 ms, a time slot configuration of the scheduling cell and a time slot configuration of the scheduled cell are (config#6, config#2), (config#6, config#5), (config#0, config#2), (config#0, config#4) or (config#0, config#5) defined by the 3rd Generation Partnership Project (3GPP), and the Hybrid Automatic Repeat Request (HARQ) of the Physical Uplink Shared Channel (PUSCH) on the scheduled cell follows the timing mode of the time slot configuration of config#1 defined by the 3GPP.

In the present disclosure, since the time slot configuration of config#1 defined by the 3GPP is used, it is ensured that there is at least one sub-frame being able to work properly in the PUSCH on the scheduled cell and the transmission efficiency is maximized except for two circumstances where the time slot configuration of the scheduling cell and the time slot configuration of the scheduled cell are (config#6, config#0) and (config#0, config#6) defined by the 3GPP.

### BRIEF DESCRIPTION OF THE DRAWINGS

The accompany drawing is used to provide a further understanding of the present disclosure, to constitute part of the specification, and to serve to explain the present disclosure along with embodiments of the present disclosure, but not construed as limiting the present disclosure. In the drawing:

FIG. 1 is a comparison chart showing sub-frames of PUSCH HARQ on a scheduled cell according to the first embodiment of the present disclosure.

### DETAILED DESCRIPTION

Below in connection with the accompanying drawing, embodiments of the present disclosure will be described in detail.

In order to solve the problem that when a Round-Trip Time (RTT) of a scheduling cell is not equal to 10 ms, i.e., when the scheduling cell and a scheduled cell are in Case D defined by the 3rd Generation Partnership Project (3GPP), a Physical Uplink Shared Channel (PUSCH) Hybrid Automatic Repeat Request (HARQ) on a scheduled cell cannot be achieved in the related art, two solutions are provided as follows.

A first method, which is applied in a PUSCH HARQ timing for CA, is that, when the RTT of the scheduling cell is not equal to 10 ms i.e., when the scheduling cell and the scheduled cell are in Case D defined by the 3GPP, a time slot configuration of the scheduling cell follows config#0 or config#6 defined by the 3GPP, and a time slot configuration of the scheduled cell follows any one from config#0 to config#6 defined by the 3GPP.

Under the above conditions, all HARQs of the PUSCH on the scheduled cell follow a timing mode of a time slot configuration of config#1 defined by the 3GPP. Specifically, in the time slot configuration of the config#1, the 0th, 4th, 5th and 9th sub-frames are downlink sub-frames, the 1st and 6th sub-frames are special sub-frames, and the 2nd, 3rd, 7th and 8th sub-frames are uplink sub-frames.

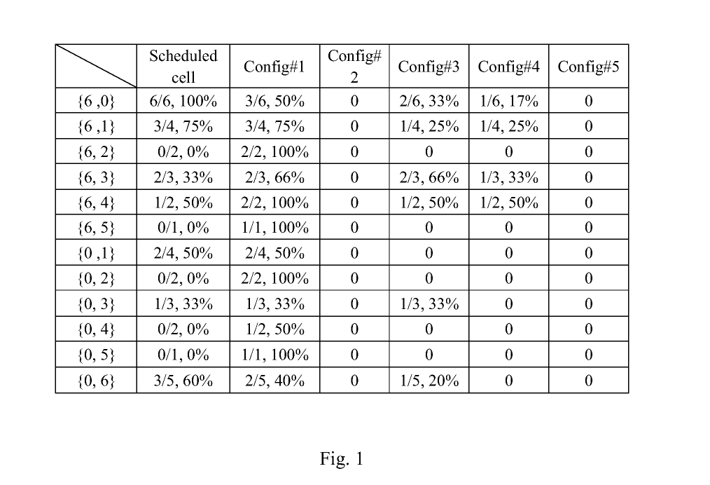

By using the above technical solution, the specific effects can be seen in FIG. 1, which shows a comparison of the sub-frames of PUSCH HARQ on the scheduled cell. Using the timing mode of config #1, it can be ensured that there is at least one UL sub-frame in which transmission is conducted normally. FIG. 1 shows the transmission efficiencies of UL time slots when different configurations are used on the scheduled cell. Having (scheduling cell, scheduled cell)=(config#6, config#1) as an example, there are four (4) UL time slots when PUSCH HARQ on the scheduled cell follows the timing mode of config#1. And if the timing mode of PUSCH HARQ on scheduled cell is used, then there are three (3) UL time slots in which transmission may be conducted normally, therefore UL transmission resource utilization ratio is 75%; if the timing mode of config#1 is used, the resource utilization ratio is also 75%; if the timing mode of config#2 is used, then there is no UL time slot in which the transmission can be conducted; similarly, if the timing mode of config#3 and the timing mode of config#4 are used, the transmission efficiencies are both 25%; and if the timing mode of config#5 or the scheduling cell is used, then there is no UL time slot in which the transmission can be conducted.

In the above solution, the time slot configuration of config#1 defined by the 3GPP is used, which ensures that there is at least one sub-frame being able to work properly in the PUSCH on the scheduled cell and the transmission efficiency is maximized except for two circumstances where the time slot configuration of the scheduling cell and the time slot configuration of the scheduled cell are (config#6, config#0) and (config#0, config#6) defined by the 3GPP.

A second method, which is applied in a PUSCH HARQ timing for CA, is that, when the RTT of the scheduling cell is not equal to 10 ms i.e., when the scheduling cell and the scheduled cell are in Case D defined by the 3GPP, a time slot configuration of the scheduling cell follows config#0 or config#6 defined by the 3GPP, and a time slot configuration of the scheduled cell follows any one from config#0 to config#6 defined by the 3GPP.

Under the above conditions, and when a time slot configuration of the scheduling cell and a time slot configuration of the scheduled cell are (config#6, config#2), (config#6, config#5), (config#0, config#2), (config#0, config#4) or (config#0, config#5) defined by the 3GPP, the HARQ of the PUSCH on the scheduled cell follows the timing mode of the time slot configuration of config#1 defined by the 3GPP. That is, five (5) situations where the time slot configuration of the scheduling cell and the time slot configuration of the scheduled cell are (config#6, config#2), (config#6, config#5), (config#0, config#2), (config#0, config#4), (config#0, config#5) defined by the 3GPP, are differentiated, and the timing mode of the PUSCH HARQ follows the time slot configuration of config#1, while in other situations it still follows the timing mode of the scheduled cell.

By this way, it is ensured that there is at least one sub-frame being able to work properly in the PUSCH on the scheduled cell.

The present disclosure further provides two CA systems, both of which can achieve the above objects.

A first Carrier Aggregation (CA) system, is that, when a Round-Trip Time (RTT) of a scheduling cell is not equal to 10 ms, a Hybrid Automatic Repeat Request (HARQ) of a Physical Uplink Shared Channel (PUSCH) on a scheduled cell follows a timing mode of a time slot configuration of config#1 defined by the 3rd Generation Partnership Project (3GPP).

In the time slot configuration of the config#1, the 0th, 4th, 5th and 9th sub-frames are downlink sub-frames, the 1st and 6th sub-frames are special sub-frames, and the 2nd, 3rd, 7th and 8th sub-frames are uplink sub-frames.

A second Carrier Aggregation (CA) system, is that, when a Round-Trip Time (RTT) of a scheduling cell is not equal to 10 ms, and when a time slot configuration of the scheduling cell and a time slot configuration of the scheduled cell are (config#6, config#2), (config#6, config#5), (config#0, config#2), (config#0, config#4) or (config#0, config#5) defined by the 3rd Generation Partnership Project (3GPP), the Hybrid Automatic Repeat Request (HARQ) of the Physical Uplink Shared Channel (PUSCH) on the scheduled cell follows the timing mode of the time slot configuration of config#1 defined by the 3GPP.

In the time slot configuration of the config#1, the 0th, 4th, 5th and 9th sub-frames are downlink sub-frames, the 1st and 6th sub-frames are special sub-frames, and the 2nd, 3rd, 7th and 8th sub-frames are uplink sub-frames.

It Should be noted that, the above embodiments are merely intend to illustrate but not to limit the present disclosure, and the present disclosure is also not limited to the above embodiments. All the technical solutions and improvements without departing from the spirit and scope of the present disclosure should fall within the scope of the claims of the present disclosure.

1-10. (canceled)

11. A method, which is applied in a Physical Uplink Shared Channel (PUSCH) Hybrid Automatic Repeat Request (HARQ) timing for Carrier Aggregation (CA), comprising:
when a Round-Trip Time (RTT) of a scheduling cell is not equal to 10 ms, an HARQ of the PUSCH on a scheduled cell follows a timing mode of a time slot configuration of config#1 defined by the 3rd Generation Partnership Project (3GPP).

12. The method according to claim 11, wherein when the RTT of the scheduling cell is not equal to 10 ms, the scheduling cell and the scheduled cell follow Case D defined by the 3GPP.

13. The method according to claim 12, wherein when the RTT of the scheduling cell is not equal to 10 ms, a time slot configuration of the scheduling cell follows config#0 or config#6 defined by the 3GPP, and a time slot configuration of the scheduled cell follows any one from config#0 to config#6 defined by the 3GPP.

14. The method according to claim 11, wherein when the RTT of the scheduling cell is not equal to 10 ms, and when a time slot configuration of the scheduling cell and a time slot configuration of the scheduled cell are (config#6, config#2), (config#6, config#5), (config#0, config#2), (config#0, config#4) or (config#0, config#5) defined by the 3GPP, the HARQ of the PUSCH on the scheduled cell follows the timing mode of the time slot configuration of config#1 defined by the 3GPP.

15. The method according to claim 11, wherein in the time slot configuration of the config#1, the 0th, 4th, 5th and 9th sub-frames are downlink sub-frames, the 1st and 6th sub-frames are special sub-frames, and the 2nd, 3rd, 7th and 8th sub-frames are uplink sub-frames.

16. The method according to claim 12, wherein in the time slot configuration of the config#1, the 0th, 4th, 5th and 9th sub-frames are downlink sub-frames, the 1st and 6th sub-frames are special sub-frames, and the 2nd, 3rd, 7th and 8th sub-frames are uplink sub-frames.

17. The method according to claim 13, wherein in the time slot configuration of the config#1, the 0th, 4th, 5th and 9th sub-frames are downlink sub-frames, the 1st and 6th sub-frames are special sub-frames, and the 2nd, 3rd, 7th and 8th sub-frames are uplink sub-frames.

18. The method according to claim 14, wherein in the time slot configuration of the config#1, the 0th, 4th, 5th and 9th sub-frames are downlink sub-frames, the 1st and 6th sub-frames are special sub-frames, and the 2nd, 3rd, 7th and 8th sub-frames are uplink sub-frames.

19. A method, which is applied in a Physical Uplink Shared Channel (PUSCH) Hybrid Automatic Repeat Request (HARQ) timing for Carrier Aggregation (CA), comprising:
when a Round-Trip Time (RTT) of a scheduling cell is not equal to 10 ms, a timing mode of an HARQ of a PUSCH on a scheduled cell follows a mode where the 0th, 4th, 5th and 9th sub-frames are downlink sub-frames, the 1st and 6th sub-frames are special sub-frames, and the 2nd, 3rd, 7th and 8th sub-frames are uplink sub-frames.

20. A Carrier Aggregation (CA) system, wherein when a Round-Trip Time (RTT) of a scheduling cell is not equal to 10 ms, a Hybrid Automatic Repeat Request (HARQ) of a Physical Uplink Shared Channel (PUSCH) on a scheduled cell follows a timing mode of a time slot configuration of config#1 defined by the 3rd Generation Partnership Project (3GPP).

21. The CA system according to claim 20, wherein in the time slot configuration of the config#1, the 0th, 4th, 5th and 9th sub-frames are downlink sub-frames, the 1st and 6th sub-frames are special sub-frames, and the 2nd, 3rd, 7th and 8th sub-frames are uplink sub-frames.

22. A Carrier Aggregation (CA) system, wherein when a Round-Trip Time (RTT) of a scheduling cell is not equal to 10 ms, and when a time slot configuration of the scheduling cell and a time slot configuration of the scheduled cell are (config#6, config#2), (config#6, config#5), (config#0, config#2), (config#0, config#4) or (config#0, config#5) defined by the 3rd Generation Partnership Project (3GPP), the Hybrid Automatic Repeat Request (HARQ) of the Physical Uplink Shared Channel (PUSCH) on the scheduled cell follows the timing mode of the time slot configuration of config#1 defined by the 3GPP.

23. The CA system according to claim 22, wherein in the time slot configuration of the config#1, the 0th, 4th, 5th and 9th sub-frames are downlink sub-frames, the 1st and 6th sub-frames are special sub-frames, and the 2nd, 3rd, 7th and 8th sub-frames are uplink sub-frames.
